(19) United States
(12) Patent Application Publication
(10) Pub. No.: US 2004/0185259 A1
(43) Pub. Date: Sep. 23, 2004

(54) Coating powder composition, method of use thereof, and articles formed therefrom

(76) Inventors: Edward Nicholl, Reading, PA (US); Michael Morder, Fleetwood, PA (US); Richard Haley, Reading, PA (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/768,230

(22) Filed: Jan. 30, 2004

Related U.S. Application Data
(60) Provisional application No. 60/443,776, filed on Jan. 30, 2003.

(51) Int. Cl. B32B 27/38

(52) U.S. Cl. 428/413

(57) ABSTRACT

Disclosed herein is a coating powder composition with improved melt flow properties that produces semi and high gloss coatings and comprises a polymer resin, a curing agent, a catalyst, and from 1 to 60 parts per hundred parts resin of diatomaceous earth. Also disclosed is a method of making and using the above coating powder.

### BACKGROUND

This disclosure relates to coating powder compositions, and in particular to coating powder compositions that form smooth semi-gloss to high gloss coatings.

Coating powders are dry, flowable, finely divided particulate compositions that are generally applied to substrates by electrostatic processes in which the powder particles are electrostatically charged and the substrate is earthed. The applied composition is then heated to melt and fuse the particles, and to cure the coating. The particles that do not adhere to the substrate can be recovered for reuse so that coating powders are economical in use of ingredients. Also, since coating powder compositions are generally free of added solvents, in particular organic solvents, they are accordingly nonpolluting.

A large number of coating powder compositions for different applications have been described. One particularly useful class is based on the cure of compositions comprising glycidyl(meth)acrylate ester copolymers and carboxylic acid-functional crosslinking agents in the presence of an optional catalyst, as disclosed, for example, in U.S. Pat. Nos. 3,058,947; 3,781,379; 4,091,049; and 4,346,144. For example, U.S. Pat. No. 4,091,049 discloses a coating powder composition comprising a glycidyl(meth)acrylate ester copolymer/carboxylic acid functional crosslinking agent that produces a smooth, high gloss finish. Possible additives to the coating powder composition include organic plasticizers, antistatic agents, pigments, and flow control additives, for example polydimethyl siloxane fluids, acrylic polymers such as polylauryl acrylate, polyisodecyl methacrylate, and the like, and fluorinated polymers such as the esters of polyethylene glycols and a fluorinated fatty acid. U.S. Pat. No. 4,346,144 discloses a glycidyl(meth)acrylate ester copolymer/carboxylic acid-functional crosslinking agent coating powder composition that produces a smooth, high gloss finish. Possible additives to the coating powder composition include anti-popping agents and flow control additives such as ethylene oxide modified dimethyl siloxane fluids, acrylic polymers, and fluorinated polymers similar to those described in U.S. Pat. No. 4,091,049.

Other additives for use in coating powder compositions are known, including various fillers and extenders. Fillers are most often used in coating powder compositions that provide matte and/or textured coatings. For example, U.S. Pat. No. 6,407,181 describes low gloss coatings based on a glycidyl(meth)acrylate ester copolymer resin that is crosslinked with a carboxylic acid-functional polyester polymer, which provides a matte effect. The coating powder composition optionally further includes fillers and extenders, as well as pigments, dyes, flow control agents, plasticizers, and crosslinking catalysts as desired. U.S. Pat. No. 5,922,472 discloses a wide variety of resin and crosslinkng systems including on a glycidyl (meth)acrylate ester copolymer resin that is crosslinked with polymers having unsaturated groups. The powder coating compositions may further comprise talc, mica, silica, glass, calcium carbonate, barium sulfate, ammonium chloride alumina, antimony trioxide, clay zinc sulfide, asbestos, and diatomaceous earth to opacify or lower the gloss of the powder coating. U.S. Pat. No. 5,661,219 discloses use of compostions comprising a variety of unsaturated resins, including epoxyacrylate resins, together with a derivatized carboxylic acid functional compound that regenerates the acid in the presence of a Lewis acid. When used to mold articles, the compositions may comprise known extenders such as calcium sulfate, calcium silicate, clay, diatomaceous earth, alumina, graphite, mica, metal flake, glass balloons, and the like.

Coating powder compositions may be formulated in a variety of ways so as to impart desired characteristics into the cured coating produced, for example gloss level (e.g., low or high gloss), surface texture (e.g., smooth, microtextured, or rough), consistency in application, melt flow, stability, shelf life and cure temperature. However, certain combinations of desired characteristics may be difficult to achieve, particularly in a given application. For example, one unmet need has been a coating powder composition that provides semi- or high-gloss powder coatings in combination with either smooth or slightly rough surfaces as desired over wood surfaces, that cures at temperatures below 325° F. (163° C.), and that has a relatively high melt flow without sagging, leaving bare edges, or highlighting any fiber defects in the wood. This combination is difficult to achieve because high melt flow may also contribute to undesired outcomes, including sagging of the coating, bare edges, and fiber defects on the coated surface, yet adjustments that reduce the melt flow to address these drawbacks may in turn result in an unacceptably rough and defective finish. Accordingly, there remains a need for coating powder compositions that when used, provide a coating having a combination of characteristics including semi- to high gloss, smooth finish on engineered wood, and that have melt flow properties to produce suitable coatings on complex surfaces such as cabinet doors.

### SUMMARY OF THE DISCLOSURE

In a first aspect of the present invention, there is provided a coating powder composition comprising a solid, particulate film-forming glycidyl(meth)acrylate resin, a carboxy-functional curing agent, an optional catalyst, and 1 to 60 parts per hundred parts resin of diatomaceous earth, wherein the melt flow of the coating powder composition measured at 300° F. at a 35° angle is less than 150 mm, and wherein the cured coating powder composition has a 60° gloss of greater than 20 units.

In a second aspect, there is provided a method for coating an article comprising contacting the article with a solid, particulate film-forming polymer resin, a curing agent, a catalyst, and 1 to 60 parts per hundred parts resin of diatomaceous earth, wherein the melt flow of the coating powder composition measured at 300° F. at a 35° angle is less than 150 mm, and wherein the cured coating powder composition has a 60° gloss of greater than 20 units; fusing the coating powder to form a powder coating; and curing the powder coating.

In another aspect, there is provided an article comprising a powder coating formed by depositing, fusing, and curing a solid, particulate film-forming polymer resin, a curing agent, a catalyst, and 1 to 60 parts per hundred parts resin of diatomaceous earth, wherein the melt flow of the coating powder composition measured at 300° F. at a 35° angle is less than 150 mm, and wherein the cured coating powder composition has a 60° gloss of greater than 20 units.

### DETAILED DESCRIPTION

It has been unexpectedly discovered that addition of diatomaceous earth to a powder coating composition that forms medium- or high-gloss coatings will improve the melt flow of the coating powder on wood without adversely affecting its medium- or high-gloss properties. This finding is unexpected in that use of a filler such as diatomaceous earth would have been expected to be detrimental to the smoothness of the cured powder coating. It has further been unexpectedly found that addition of an acrylic flow control agent comprising an acrylonitrile-modified polyalkyl acrylate, acrylonitrile modified polyalkyl acrylic, or combination thereof, provides a synergistic improvement in the flow properties when used together with diatomaceous earth, particularly as the concentration of diatomaceous earth is increased. The acrylic modifier may be deposited on a carrier such as silica. Without being held to theory, it is believed that the synergistic effect arises from the particular combination of elements used to produce the powder coatings described herein, in particular, compatibility between the surface tension of the wood substrates to be coated, the polymer resin, the diatomaceous earth, and the acrylic flow control agent lead to the observed improvement in characteristics of the coating powder compositions.

As used herein, a coating powder means a solid, particulate, film-forming composition, whereas a powder coating means the film formed on a substrate by fusing and curing a coating powder. The film-forming component of the composition comprises a glycidyl(meth)acrylate copolymer (“GMA resin”) and a carboxy functional curing agent. The GMA resin is a copolymer which may be produced by copolymerizing 20 to 100 weight percent (wt %) glycidyl acrylate or glycidyl methacrylate and up to 80 wt % other α,β-ethylenically unsaturated monomers such as methyl(meth)acrylate, ethyl(meth)acrylate, butyl(meth)acrylate and styrene. Use of the term “(meth)acrylate” herein is meant to encompass methacrylates, acrylates, or mixtures of methacrylates and acrylates.) Epoxy equivalent weights of the GMA resin are from 200 to 1,000, more preferably from 200 to 600. The GMA resin typically has a weight average molecular weight from 3,000 to 200,000, preferably from 3,000 to 20,000 as determined by gel permeation chromatography. The viscosity of the GMA is preferably from 10 to 500 poise, more preferably from 30 to 3,000 poise, as determined at 150° C. using a cone and plate viscometer.

The GMA resin can be prepared under reaction conditions known in the art.

For example, the monomers can be added to an organic solvent such as xylene and the reaction conducted at reflux in the presence of an initiator such as azo-bis-isobutyronitrile or benzoyl peroxide. In addition, GMA resins are commercially available under the trademark ALMATEX (Anderson Development Company of Adrian, Mich.).

Suitable carboxy-functional curing agents may be linear or branched, and provide a carboxyl functionality of at least two. Suitable carboxy-functional curing agents include linear aliphatic dicarboxylic acids having 4 to 20 carbon atoms, such as succinic acid, adipic acid, azelaic acid, sebacic acid, 1,12-dodecanedioic acid, hexahydrophthalic acid, 1,4-cyclohexanedicarboxylic acid, and the like. Suitable carboxy-functional curing agents further include aromatic polycarboxylic acids having about 6 to 20 carbon atoms, for example terephthalic acid, isophthalic acid, trimesic acid, tetrahydrophthalic acid, trimellitic acid, and naphthalene dicarboxylic acid. The corresponding anhydrides of any of the foregoing acids, for example terephthalic anhydride, may also be used.

Other suitable carboxy-functional curing agents are carboxy-functional polyesters, available from the reaction of polyols and polyfunctional carboxylic acids or the reaction of polyols and monomers having both —OH and —COOH functionality, wherein carboxylic functionality is provided in excess over hydroxyl functionality to provide polyester chains are carboxyl terminated.

Examples of suitable polyols for forming the polyester resin include 1,2-ethanediol, 1,3-propanediol, 1,4-butanediol, diethylene glycol, 1,6-hexanediol, neopentyl glycol, 1,10-decanediol, 1,4-cyclohexanedimethanol, trimethylolpropane, 2-methyl-1,3-propanediol, hydrogenated bisphenol A [2,2-(dicyclohexanol)propane], 2,2,4-trimethyl-1,3-pentanediol, 1,12-dodecanediol, 2-methyl-2-hydroxymethyl-1,3-propanediol, and 2-ethyl-2-hydroxymethyl-1,3-propanediol.

Examples of suitable polyfunctional carboxylic acids include succinic acid, adipic acid, azelaic acid, sebacic acid, 1,12-dodecanedioic acid, terephthalic acid, isophthalic acid, trimesic acid, tetrahydrophthalic acid, hexahydrophthalic acid, 1,4-cyclohexanedicarboxylic acid, trimellitic acid, and naphthalene dicarboxylic acid.

The carboxy-functional polyester resins may also be formed from hydroxyl terminated polyesters that are then capped with a polyfunctional carboxylic acid. The polyester resins may have a carboxylic acid functionality of at least 1.5 to 4, and preferably at least 2. A linear hydroxyl-terminated polyester resin capped with a dicarboxylic acid will have a functionality of 2. A linear hydroxyl-terminated polyester resin capped with a tricarboxylic acid, such as trimellitic anhydride, will have a functionality of four. The introduction of branching into the polyester, e.g., through the use of trimethylolpropane, or trimellitic anhydride as monomers, may achieve even higher carboxylic acid functionalities. Useful polyester resins preferably have a Tg of 40° C. or higher, preferably 50° C. or higher but less than 65° C. The polyester resins typically have weight average molecular weights of 2,000 to 5,000, and may be amorphous, highly crystalline, or a combination of the two. The polyester resins comprise relatively short chains having acid numbers of 15 to 200, preferably 25 to 90. The particulate film-forming polymeric resins may also comprise a mixture of polyester resins.

Another type of carboxy-functional crosslinking agent is the carboxylic acid-functional acrylic polymers typically derived from the copolymerization of acid functional monomers with non-acid functional monomers. The carboxylic acid-functional acrylic polymers have acid numbers from 15 to 200, where the higher acid number of the acrylic polymers promote rapid cross-linking and thereby low temperature curing, weight average molecular weights from 1,000 to 20,000, Tgs of 40 to 65° C., and softening temperature are from 60 to 80° C.

Suitable acid functional monomers include acrylic acid, methacrylic acid, maleic acid, fumaric acid, citraconic acid, and the like. One or more of such acid functional monomers may be used.

Non-acid functional monomers may include monoesters, diesters, triesters, or tetraesters of acrylic and methacrylic acids, for example, methyl, 2-ethyl hexyl, n-butyl, n-hexyl, hydroxyethyl, octyl, 2-ethoxy ethyl, t-butyl, 1,5-pentanediol, N,N-diethylaminoethyl, ethylene glycol, 1,3-propanediol, decamethylene glycol, decamethylene glycol, 1,4-cyclohexanediol, 2,2-propane, glycerol, tripropylene glycol, 2,2-di(p-hydroxyphenyl)-propane, triethylene glycol, polyoxyethyl-2,2-di(p-hydroxyphenyl)propane, polyoxypropyltrimethylol propane, butylene glycol, 1,2,4-butanetriol, 2,2,4-trimethyl-1,3-pentanediol, pentaerythritol, pentaerythritol, 1,5-pentanediol, and 1,4-benzenediol esters. Styrene and substituted styrene, such as 2-methyl styrene and vinyl toluene along with vinyl esters such as vinyl acrylate and vinyl methacrylate, may also be copolymerized with the acid functional monomers to obtain desired acid numbers.

The carboxy functional curing agent is generally used in an amount sufficient to provide 0.3 to 1.0 mole of carboxyl functionality per mole of epoxy functionality. Sebacic acid, for example, which is preferred, may be used in an amount of up to 30 parts per hundred parts by weight of resin and curing agent (phr), preferably 10 to 22 phr.

The coating powder compositions may further comprise a catalyst to accelerate cure. Preferably, the catalyst is active at less than or equal to 325° F. (163° C.). When present, the catalyst may be used in an amount of 0.1 to 30 phr. Suitable catalysts include imidazoles, organoborate salts, polyamines, phenolics, and combinations comprising at least one of the foregoing catalysts.

Preferred imidazole catalysts include those represented by the formula:

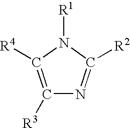

wherein R¹-R⁴ are each independently hydrogen, C₁-C₁₂ alkyl, C₆-C₁₈ aryl, C₇-C₁₈ arylalkyl, or C₇-C₁₈ alkylaryl. Adducts of the above imidazoles with a bisphenol A epoxy resin (available commercially as EPON® P-101 from Resolution, and ARALDITE® HT-3261 from Vantico), may also be used. More preferred catalysts include imidazole, 2-methyl imidazole, and 2-phenyl imidazole (commercially available from SKW Chemical Co.).

Suitable organoborate salt catalysts may have the formulae:

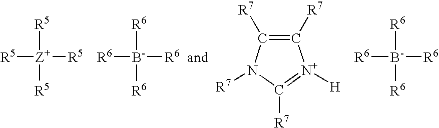

wherein Z is P, As, or N; each R⁵ is independently C₁-C₁₂ alkyl, C₂-C₁₂ alkenyl, C₆-C₁₈ aryl, C₇-C₁₈ arylalkyl, or C₇-C₁₈ alkylaryl; each R⁶ is independently C₁-C₁₂ alkyl, C₆-C₁₈ aryl, C₇-C₈ arylalkyl, C₇-C₁₈ alkylaryl, Br, Cl, I, or F; and each R⁷ is independently hydrogen, C₂-C₁₂ alkyl, C₂-C₁₂ alkenyl, C₆-C₁₈ aryl, C₇-C₁₈ arylalkyl, C₇-C₁₈ alkylaryl, C₂-C₁₂ acyl, aldehyde, carboxylate, cyano, or nitro. Specific examples of these compounds and methods for their preparation are provided in U.S. Pat. No. 3,859,379 to Kitamura et al.

Suitable catalysts further include polyamine catalysts, for example, ethylene diamine, isophorone diamine, cyclohexylenediamine, and fluorinated diamines including 4,4′-hexafluoroisopropylidene bis-aniline. In a preferred embodiment, the catalyst may be converted from their usual liquid state into a friable solid that is pulverized. A friable catalyst may be selected from a blocked polyamine such as an adduct of an epoxy resin having an equivalent weight of from 400 to 800 AMU and an aliphatic polyamine having a primary, secondary, and/or tertiary amino group. The epoxy resin portion of the adduct may be aromatic or aliphatic, as exemplified by the bisphenol-based resins mentioned above and the aliphatic analogs thereof, respectively. Suitable catalysts derived from polyamines having a primary amino group include those available under the trade name HT 835 (Ciba-Geigy) and ANCAMINE® 2337 XS (Air Products). An example of an epoxy adduct of an aliphatic polyamine having a secondary amino group is ANCAMINE® 2014 AS (Air Products), which may be preferred for white and light colored coatings.

Suitable phenolic catalysts may have at least two terminal hydroxyl groups such as bisphenol A and the endcapped diglycidyl ether of bisphenol A. Examples of preferred phenolic catalysts for the epoxy resin components include those commercially available under the trade names D.E.H. 87®, D.E.H. 85®, and D.E.H. 84®, (Dow Chemical Company), all of which are believed to be bisphenol A endcapped diglycidyl ethers of bisphenol A. Other phenolic catalysts include phenol- and cresol-novolac catalysts having a hydroxy equivalent weight (HEW) of 180 to 1000 AMU. Within this range, catalyst having an HEW of greater than or equal to 200 AMU and less than or equal to 450 AMU are preferred.

Other catalysts that can be used to enhance the curing properties herein include dicyandiamide available under the trade name DYHARD 100M® (SKW Chemicals) and/or o-tolyl biguanide, available under the trade name CASAMINE OTB° (Swan Chemical). Combinations comprising at least one of the foregoing catalysts may also be used. For example, a phenolic catalyst may be used in combination with an imidazole such as 2-methylimidazole or 2-phenylimidazole pre-dispersed at 0.05 to 5 weight percent, based on the total amount of catalyst present.

Diatomaceous earth suitable for use herein includes the natural powder, as well as the calcined form, the flux-calcined form, or a combination comprising at least one of the foregoing, with flux-calcined diatomaceous earth being more preferred. Suitable particle sizes may vary, having an average largest dimension of 5 to 120 micrometers, for example. Preferably, the average largest dimension of the particles is 20 to 50 micrometers. Diatomaceous earth is present in the composition in an amount of 1 to 60 phr. Preferably, within this range, the amount of diatomaceous earth is greater than or equal to two phr, with greater than or equal to five phr more preferred. Also within this range, diatomaceous earth is less than or equal to 50 phr, with less than or equal to 40 phr is more preferred. The melt flow of the coating powder composition measured at 300° F. at a 35° angle is less than 150 mm, which allows complete coverage of complex surfaces without bare spots or sagging. The cured coating powder composition has a 60° gloss of greater than 20 units.

As stated above, a synergistic effect is observed when a specific type of flow control agent is used in combination with the diatomaceous earth. In particular, it has been found that use of RESIFLOW PL-200, from Estron Chemical, Inc., yielded both medium- and high-gloss coatings with smooth surfaces wood substrates. Infrared analysis of the PL-200 product indicates that it is an acrylonitrile modified polybutyl acrylate or an acrylonitrile modified polybutyl methacrylate on a silica support. Flow control agents are generally liquids that have been converted to powder form by absorption onto silica-type materials. Acrylonitrile modified polyalkyl acrylates, acrylonitrile modified polyalkyl methacrylates, or mixtures thereof are therefore within the scope of the invention, wherein the alky groups have one to eight carbon atoms. The acrylic flow control agents are used in amounts of 0.5 to 5.0 phr.

The coating powder compositions may also comprise one or more additives known in the art including other flow control agents, dry flow agents, antioxidants, pigments, optical brighteners, extenders, UV light stabilizers, and combinations comprising at least one of the foregoing additives.

Other flow control agents include non-ionic fluorinated alkyl ester surfactants, non-ionic alkylarylpolyether alcohols, silicones, and combinations comprising at least one of the foregoing flow control agents. Examples of flow control agents include the MODAFLOW® poly(alkyl acrylate) products available from Monsanto; 2-hydroxy-1,2-diphenylethanone (Benzoin available from DSM, Inc.); substituted acetylenic diols (e.g., SURFYNOL® P200, available from Air Products); and combinations comprising at least one of the foregoing.

Suitable dry flow agents, also referred to as glidants, include fumed silica (e.g., CAB-O-SIL® by Cabot Corporation), fumed alumina (e.g., Aluminum Oxide C by Degussa Corporation), or combinations comprising at least one of the foregoing. When present, the dry flow agent may be used in an amount of 0.05 to 5 wt %, based on the total weight of the composition.

Pigments may be used to adjust color and opacity. Suitable pigments include titanium dioxide, carbon black, phthalocyanine blue, phthalocyanine green, quinacridone red, perylene red, isoindolone yellow, dioxazine violet, scarlet 3B lake, red 188 azo red, azo pigment yellow 83, iron oxide pigments, and combinations comprising at least one of the foregoing. When present, the pigment may be used in an amount of up to 100 phr.

Suitable extenders, also known as fillers, include calcium carbonate, barium sulfate, dolomite, wollastonite, talc, mica, and combinations comprising at least one of the foregoing. When present, the extender may be used in an amount up to 120 phr. Within this range, an extender amount of greater than or equal to 10 phr is preferred. Also within this range an extender amount of less than or equal to 80 phr is preferred.

Suitable antioxidants, which prevent discoloration of the powder coating, include sodium hypophosphite, tris-(2,4-di-t-butyl phenyl) phosphite (available as IRGAFOS® 168 from Ciba-Geigy), calcium bis([monoethyl(3,5-di-t-butyl-4-hydroxybenzyl)phosphonate] (available as IRGANOX® 1425 from Ciba-Geigy), and mixtures comprising at least one of the foregoing antioxidants. When used, antioxidants may be present in the composition at 0.5 to 2.0 phr.

Suitable optical brighteners include 2,2′-(2,5-thiophenediyl)bis(5-t-butylbenzoxazole) (UVITEX® OB from Ciba-Geigy). When used, optical brighteners may be present at 0.1 to 0.5 phr. UV light stabilizers suitable for use herein include di[4(2,2,6,6-tetramethyl piperidinyl)]sebacate, benzotriazoles, such as 2(2′hydroxy-5′-methylphenyl)benzotriazole, 3-(2′-hydroxy-3′,5-di-t-butylphenyl)benzotriazole, 2-(3′,5′-di-tert-butyl-2′-hydroxyphenyl)₅ chlorobenzotriazole, and nickel bis[O-ethyl(3,5-di-tert-butyl-4-hydroxy benzyl)]phosphonate. The UV light stabilizers may be present at 0.1 to 5 (wt %), and preferably from 0.1 to 3 wt %, based on the total weight of the composition.

There is no particular limitation on the method used for forming the coating powder. Preferred methods include melt mixing, wherein dry ingredients are weighed and then mixed in a batch mixer using a horizontal plow mixer or a lesser intensity tumble mixer. Mixing times may be from 1 to 3 minutes for the high intensity mixers to 30-60 minutes for the tumble mixers. This premix may then be further melted in either a single screw or a twin screw extruder for 0.5 to 1 minute, generally at 140° F. to 180° F., so that the extruder temperature is controlled to minimize any curing and gelation taking place in the extruder. Accordingly, the extruder temperatures are preferably lower than the cure temperatures of the film-forming systems.

After extrusion, the composition is cooled and may form a friable solid (e.g., in chip form). The cooled composition is then milled and classified (e.g., using a hammer mill), to achieve the desired particle size. A suitable particle size may be achieved, for example, by screening from 60 mesh (for coarse) to 200 mesh (for fine), preferably at 140 to 200 mesh. Preferred average particle size is typically 20 to 80 micrometers, wherein scalping at 100 mesh is used to remove coarse particles. The particle distribution is preferably 10-15 wt % of particles below 11 micrometers and 0-4 wt % of particles above 88 micrometers, based on the total weight of the composition.

The coating powder may be applied to substrates by electrostatic fluidized beds, electrostatic spray guns, and/or triboelectric guns, in which the powder coating particles are electrostatically charged and the substrate is grounded or oppositely charged. Preferably, the substrate is heated (and may optionally be pre-heated prior to application) to aid the melt flow and coalescence of the particles in forming a smooth continuous film. Coating powders are generally applied to achieve a cured coating thickness of 24.5 micrometers, (1.0 mil) to 102 micrometers (25 mils), preferably least 38 to 100 micrometers (1.5 to 4 mils). A suitable film thickness on medium density fiberboard (MDF) is 4 to 8 mils. However, film thickness may be less than 20 micrometers and may be greater than 150 micrometers depending on the application.

Once applied to the substrate, the coating film is then cured without degrading the substrate. Heating may be performed in infrared, convection ovens, or a combination of both, with infrared oven curing preferred. Time and temperature of the final cure will vary somewhat depending on the film-forming systems employed and on the conditions of use. Typical time and temperatures are from 1 minute at 325° F. to 30 minutes at 275° F., preferably 5 minutes at 300° F. Regardless of cure time and temperatures employed, the powder coatings preferably generate substrates having a visually consistent appearance.

The composition is particularly useful in the coating of heat-sensitive substrates such as paper, cardboard and wood products. Wood is herein defined as any lignocellulosic material, whether it comes from trees or other plants, and whether it be in its natural forms, shaped in a saw mill, separated into sheets and made into plywood, or chipped and made into particleboard, or whether its fibers have been separated, felted, or compressed. It is exemplified by lumber, panels, molding, siding, oriented strand board, hardboard, or medium density fiberboard (MDF). Fiberboard having a pattern such as a simulated wood grain printed on its surface, rather than on a paper laminated to that surface, and a coating powder of this invention over said pattern has the appearance of natural wood. MDF is a particularly valuable coating substrate including that used in forming cabinet fronts and doors.

Substrates preferably have a moisture content of 3 to 10% by weight. The substrate may also be treated to enhance electrical conductivity. Thus, a porous substrate such as particleboard, pre-coated with a conductive liquid coating composition and cured may serve as a substrate for the coating powder. The curable coating powder is also useful for coating plastic parts including the interior and exterior of automobiles.

In view of the relatively low melt flow, the coating powder compositions described herein form surprisingly smooth coatings having a semi or high gloss finish, without sagging and surface defects. This is surprising in that the addition of diatomaceous earth to coating powders is typically associated with producing rough, low gloss coatings. They also cure well at low temperatures making them especially useful for coating temperature sensitive substrates such as wood and plastics.

Some embodiments of the invention will now be described in detail in the following examples.

### EXAMPLES

Coating powder compositions containing GMA resin (ALMATEX PD-7690 from Anderson Developments of Michigan), sebacic acid as a curing agent, 2-phenyl imidazole as a catalyst and either RESIFLOW PL-200 or MODAFLOW 2000 as a flow control agent were combined in proportions described in the Table below. A flux-calcined diatomaceous earth was obtained from Grefco Mineral Inc., under the trade name DICALITE 200.

First, the components were bag blended, followed by melt mixing in a 30 millimeter (mm) twin screw extruder. The extrudate was cooled, treated with 2% fumed alumina by weight, ground in a laboratory grinder and classified through a 200 mesh screen.

Test strips of MDF (medium density fiberboard) panels (6 by 6 by 1 inch) were heated for 10 to 15 minutes at 375° F. to achieve a surface temperature of 150 to 225° F. The powder coating was then applied via electrostatic spray to the pre-heated fiberboard substrate and cured at 375° F. for 5 minutes.

Melt flow of the coating powder composition was determined using a pellet of powder having a diameter of 12.7 mm and a thickness of 6 mm placed on a hot plate set at 300° F. (148.9° C.) at an inclination angle of 35 degrees from horizontal. The pellet was allowed to melt and the length of the flow down the incline of the plate, as measured in millimeters, was recorded as the melt flow.

The 60° Gloss measurement was conducted using a specular gloss meter geometry of 60°.

Smoothness was evaluated according to the Powder Coating Institute (PCI) guidelines, by comparison to a set of ten “Visual Smoothness Panels” available from PCI, 2121 Eisenhower Avenue, Suite 401, Alexandria, Va. 22314, USA.

Is there a measurement for smoothness, or is it just a visual evaluation? Particular compositions and results for Examples 1-3 are shown in Table 1. Table 1.

TABLE 1

| | Comparative | | |
|---|---|---|---|
| | Example 1 | Example 2 | Example 3 |
| Component | | | |
| ALMATEX PD-7690 | 84 | 84 | 84 |
| Sebacic Acid | 16 | 16 | 16 |
| 2-phenyl imidazole | 0.5 | 0.5 | 0.5 |
| Benzoin | 0.5 | 0.5 | 0.5 |
| MODAFLOW 2000 | 1 | 0 | 0 |
| Titanium dioxide TR-93 | 20 | 30 | 20 |
| DICALITE 4200 | 0 | 5 | 35 |
| RESIFLOW PL-200 | 0 | 3 | 3 |
| Property | | | |
| Melt Flow, mm | >150 | 69 | 68 |
| 60° Gloss | 80 | 77 | 42 |
| Appearance | Sagging | Smooth | Slight orange |
| | | | peel |
| PCI Rating | 9 | 8 | 7 |

As is shown in Table 1, significant reductions are observed in melt flow when diatomaceous earth and RESIFLOW PL-200 are added to the compositions. Melt flow improves from greater than 150 mm to 68-69 mm. The 60° gloss is about 70 to 85 units indicating a high gloss finish. When the amount of diatomaceous earth is increased to 35 phr (Example 3), the melt flow remains unaffected and a semi gloss finish of 35-40 units and exhibiting a slight orange peel is achieved. Examples 2 and 3 exhibited no sagging, bare edges or fiber defects, and a smooth finish consistent with the desired outcome.

Compositions and results for Example 4-8 are shown in Table 2 below:

| | Comparative | Example | Example | Example |
|---|---|---|---|---|
| | Example 4 | 5 | 6 | 7 |
| Component | | | | |
| ALMATEX PD-7690 | 84 | 84 | 84 | 84 |
| Sebacic Acid | 16 | 16 | 16 | 16 |
| 2-phenyl imidazole | 0.5 | 0.5 | 0.5 | 0.5 |
| Benzoin | 1.2 | 1.2 | 1.2 | 1.2 |
| MODAFLOW 2000 | 0 | 0 | 0 | 3 |
| Titanium dioxide | 30 | 30 | 30 | 30 |
| TR-93 ® | | | | |
| DICALITE 4200 ® | 2 | 0 | 2 | 2 |
| RESIFLOW | 0 | 3 | 3 | 0 |
| PL-200 ® | | | | |
| Pigment | 0.047 | 0.047 | 0.047 | 0.047 |
| Property | | | | |
| Melt Flow, mm | 120 | 105 | 84 | 94 |
| 60° Gloss | 74 | 87 | 84 | 77 |
| PCI rating | 1-2 | 7 | 8-9 | 7 |
| Appearance | Fisheyes | Moderate | Slight | Slight |
| | | orange | orange | orange |
| | | peel | peel | peel; |
| | | | | slightly |
| | | | | grainy |
| Film thickness (mils) | 6-8 | 6-8 | 6-8 | 6-8 |
| MEK 50 (double rubs) | very good | very good | very good | very good |

As may be seen from the above data, use of a combination of the Resiflow with the diatomaceous earth and the Resiflow provides synergistic improvement over either additive used separately.

We claim:

1. A coating powder composition comprising
a glycidyl methacrylate copolymer;
a carboxy-functional curing agent;
an optional catalyst, and
1 to 60 phr of diatomaceous earth, wherein the melt flow of the coating powder composition measured at 300° F. at a 35° angle is less than 150 mm, and wherein the cured coating powder composition has a 60° gloss of greater than 20 units.

2. The coating powder composition of claim 1, wherein the curing agent comprises sebacic acid.

3. The coating powder composition of claim 1, wherein the catalyst comprises a phenol having at least two terminal hydroxyl groups, a dicyandiamine, an o-tolyl biguanide, an organoborate salt, a polyamine, an imidazole represented by the formula: 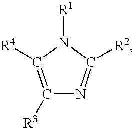
wherein R¹-R⁴ are each independently hydrogen, C₁-C₁₂ alkyl, C₆-C₁₈ aryl, C₇-C₁₈ arylalkyl, or C₇-C₁₈ alkylaryl, or a combination comprising at least one of the foregoing catalysts.

4. The coating powder composition of claim 3, wherein the catalyst is imidazole, 2-methyl imidazole, 2-phenyl imidazole, or a combination comprising at least one of the foregoing catalysts.

5. The coating powder composition of claim 1, wherein the diatomaceous earth is flux-calcined diatomaceous earth.

6. The coating powder composition of claim 1 further comprising a pigment, an dyes, a filler, an extender, a flow control agent, a plasticizer, or a combination comprising at least one of the foregoing.

7. The coating powder composition of claim 6, wherein the flow control agent is an acrylonitrile-modified polyalkyl acrylate, an acrylonitrile-modified polyalkyl methacrylate or a combination comprising at least one of the foregoing, wherein the alkyl group has one to eight carbon atoms,

8. The coating powder composition of claim 7, wherein the flow control agent is on a silica carrier, and is an acrylonitrile-modified polybutyl acrylate, an acrylonitrile-modified polybutyl methacrylate, or a combination comprising at least one of the foregoing.

9. A method of forming a powder coating on a substrate, comprising:
applying a coating powder composition comprising
a glycidyl methacrylate copolymer;
a carboxy-functional curing agent;
an optional catalyst, and
1 to 60 phr of diatomaceous earth, wherein the melt flow of the coating powder composition measured at 300° F. at a 35° angle is less than 150 mm, to at least a portion of a wood substrate; and
heating the applied composition at a temperature of less than 131° C. and for a period of time effective to fuse and cure the composition to produce a smooth coating having a 60° gloss of greater than 20 units.

10. The method of claim 9, wherein the substrate is oriented strand board, hardboard, medium density fiberboard, or a combination comprising at least one of the foregoing.

11. An article formed by the method of claim 9.
